(19) United States
(12) Patent Application Publication
(10) Pub. No.: US 2014/0274318 A1
(43) Pub. Date: Sep. 18, 2014

(54) Game Access System

(71) Applicant: Lottorolla INC., Vaughan (CA)

(72) Inventor: Filip Bronshteyn, Toronto (CA)

(21) Appl. No.: 13/924,092

(22) Filed: Jun. 21, 2013

Related U.S. Application Data
(60) Provisional application No. 61/783,252, filed on Mar. 14, 2013.

(51) Int. Cl. G07F 17/32

(52) U.S. Cl. CPC G07F 17/3241
USPC 463/25

(57) ABSTRACT

A method of authorizing game play associated with an online game server advantageously involves the purchase of a prepaid right to play one or more games available on the server. The prepaid right preferably includes a unique URI having an associated wallet essentially funded as part of the purchase amount. The user accesses the unique URI to commence game play on the server with wins and losses financially tracked using the wallet. The invention is also directed to the game card preferably having the unique URI and associated wallet to allow game play.

This application claims benefit of priority under 35 U.S.C. sctn.119(e) of U.S. provisional application Ser. No. 61/783,252 titled “GAME ACCESS SYSTEM” filed on Mar. 14, 2013, which is incorporated herein by reference in its entirety.

### FIELD OF THE INVENTION

The present invention relates to online gaming systems and in particular to a simplified approach for accessing and initiating play of one or more games.

### BACKGROUND OF THE INVENTION

Online gaming systems and online gaming servers having games of chance are widely available and can be played using many different input terminals.

Early online gaming systems were accessed using conventional computer terminals. Tablets, smart phones, portable computers and other internet enabled devices are now the input terminal of choice.

Lottery type systems, perhaps due to regulation and early government involvement have developed as a separate group and typically include specialized computer hardware including distributor terminals that securely communicate with a central game server.

There are also a host of non-government web based game servers in various jurisdictions that allow users to remotely play and place wagers with respect to casino type games. These online casino games typically require a user to register with the online game provider including establishing and funding an account prior to initiating game play. The actual funding of the account typically includes a credit card or debit card transaction completed over the internet. However there remains a general reluctance by a number of potential casual players to proceed with this type of credit transaction and personal information. For serious online players this is not a significant obstacle.

There is a significant group of casual type players who may wish to participate in online games where the amounts being charged and wagered with respect to the individual games of chance are significantly lower. In general the casual player is interested in the game entertainment value and the gambling component is secondary. The present invention provides a simplified method and system for allowing such casual users to access and initiate game play preferably without establishing an identified user account.

### BRIEF DESCRIPTION OF THE DRAWINGS

Preferred embodiments of the invention are shown in the drawings, wherein:

FIG. 1 is a front view of a game card;

FIG. 2 is a back view of the game card in FIG. 1;

FIG. 3 is a front view of an alternate game card;

FIG. 4 is a back view of the game card in FIG. 3;

FIG. 5 is a front view of yet a further game card;

FIG. 6 is a back view of FIG. 5; and

FIG. 7 is a flow chart of the system with a geographic qualifying provision.

### DETAILED DESCRIPTION OF THE PREFERRED EMBODIMENTS

In the present game system a user may remain anonymous as the purchase of the right to play one or more games can be a cash transaction. In a preferred embodiment the user purchases a game card identifying a particular game or series of games having a unique URI (unique resource identifier). This particular pre-generated unique URI constitutes the user's disposable, personal gaming account and is linked to a particular game or games and a wallet on a game server or may also be linked to a particular game having a predetermined outcome. An example of a game with a predetermined outcome is a type of lottery ticket where the outcome is already known. The purchase of the game card funds the wallet and allows the player to play one or more games of chance linked to the unique URI. Wins and losses are effectively tracked by the wallet associated with the particular URI and the purchaser of the game card is the only one who can effectively play the game utilizing the unique URI as it is otherwise difficult to determine. It is possible to include further security features with respect to the URI, such as a 4-digit security code associated with each card that is required to be inputted from time to time. For example the first time the unique URI is used to initiate game play the game server may require a user to enter the security code. Other security arrangements can also be used.

In another embodiment, a URI could be a common, specific predefined URI linked to a specific game having a preloaded wallet of specific amount. A PIN would then be provided to the user at the time of purchase.

Accessing the wagering application using the common URI requires the user to enter the PIN to authenticate the game purchase and provide access to the game and the wallet. The PIN does not carry any pre-paid monetary value, is not associated with any pre-paid amount and is not used to fund the user's account, as the amount loaded in the wallet of the associated wagering application has already been pre-established. The PIN is only used for purposes of authenticating a game purchase.

The common URI is then permanently appended with the PIN information or other unique parameters to constitute the user's unique, personal gaming account for the duration of the game's life (i.e. until the wallet is no longer able to fund game play).

The term game card is used to describe a carrier having a unique URI associated therewith that a purchaser can use to access a game. Other arrangements allowing a user to conveniently access a purchased URI are described in later embodiments of the invention. Therefore a game card is only a preferred carrier and one that allows many existing distributors of lottery type tickets to sell a gaming product.

The game card 100 of FIG. 1 includes on the face thereof the game title 102, namely CASINO, in combination with the game price 104, in this case ε30. The ε30 also preferably corresponds to a game wallet that is associated with this particular game card that allows the user to access and play the identified games. The game card shown in FIG. 1 includes a detachable card 106a which complies with the bank card specification CR80. The CR80 specification is essentially the bank card standard required for ATM compatibility. Complying with specification accommodates a preferred redemption procedure.

FIG. 2 shows the back surface of the game card 100 namely a back face 120 that again includes the game title 122, game instructions 124, as well as a QuiQode™ 126 which is commonly referred to as 2 dimensional code such as a QR Code. (The term QuiQode is the Applicant's designation for the 2 dimensional code that is linked to the game and wallet that have been purchased). Basically this is a machine scannable code that when read by an appropriate scanner provides access to a particular URI. A number of different machine scannable codes can be used. These machine scannable codes are not easily decipherable by a user without an appropriate device.

The back face 120 also includes a removable portion 128 that partially hides the QuiQode™ 126 and acts as a security measure. It is not possible to identify the unique URI using the QuiQode™ 126 without first removing the removable block 128. This is a typical scratch removable latex type cover that must be removed in order that the QuiQode™ 126 can be properly scanned. To ensure that the QuiQode™ 126 is properly scanned, it is important that all of the removable cover be removed to properly expose the underlying portion of the QuiQode™ 126. Failure to remove a portion of the removable cover overlying the QuiQode™ 126 will result in an incorrect scan.

The back face 120 of the game card 100 also preferably includes a 4-digit security code shown as 130. It can be appreciated that this security code could be longer or shorter and it also includes a removable block 132. The user removes the removable block 132 to expose the security code typically when the unique URI is first used to access a game server, the game server may prompt the user to enter the security code. Once the security code has been confirmed as correctly linked to the QuiQode™ 126, the game server assumes the game card was properly purchased and is being used by a player.

Often the player or user has used his computing device such as a smart phone to scan the QuiQode™ 126 and access the game server. Upon satisfying itself of the authenticity of the user, (i.e. through the security code or otherwise) the game server stores certain information on the computing device such that subsequent use of the smart phone to return to this URI also includes providing this additional information to the game server and this additional information is used to automatically confirm the appropriate use of the unique URI. In this way if a user has previously accessed this particular URI using the computing device, the game server recognizes this particular identity or confirms the identity based on the information provided to the game server. The game server simplifies the connection allowing the user faster access to the actual game for immediate game play. This is in contrast to earlier systems where a user is taken to a screen or series of screens to authenticate the user prior to game play.

The game card as described in FIGS. 1 and 2 provides authorization associated with a particular URI and a dollar or game value associated with a wallet associated with the particular URI. There is no requirement for the user to provide his personal information and there is no requirement for the user to provide his credit information. The user purchased the card having the unique URI associated therewith and this purchase amount funds the wallet associated with the URI.

With the system as described above, a user who wishes to participate in a particular game merely purchases a game card having a known wallet funding amount and uses the game card to access the particular URI. On initial contact with the game server the user may be prompted to enter a further security code (i.e. the 4 digit security code). Once this is completed the game is authorized and the game server provides information to the smart phone or the input terminal to further simplify the interchange of information and allow fast access to game play in subsequent sessions. For example, information can be stored in a local storage of the computing device being used, and when the user returns to the game server to play the particular game, the game server recognizes the URI and recognizes the stored information provided by the computing device and thus a user is taken directly to the game for commencement thereof. If the user wishes to use a different terminal to access the game server the particular URI can be forwarded to that terminal by email or other electronic means of communication to simplify entry.

FIGS. 3 and 4 show a game card similar to FIGS. 1 and 2 and further include a user signature field shown as 150 as well as a digital card number shown as 152. The digital card number can be helpful if a user has a particular problem regarding the use of this card.

One of the advantages of the present system is the ability to distribute these cards through a host of outlets including existing lottery distributors. In a preferred embodiment of the game card the URI and associated wallet has been preloaded with the game server and only require activation by the end user (i.e. use of the URI). In this case the distributor must take care with respect to the cards as they have inherent value.

In a different embodiment of the invention the game cards require a separate step by the seller to preload the wallet associated with the particular URI. In the embodiment of FIG. 4 the game card 100 includes a customer signature field 150 as well as the card number identified as 152. Such a card number is helpful in identifying a particular URI if a customer has difficulties and the game server support staff can quickly access the particular URI and associated information. The signature line may be needed in some jurisdictions or as part of a redemption procedure.

The game card need not be preloaded. It is possible for the distributors to have a series of these cards and the particular game price is what the card will be sold for and which the distributor will authorize with the game server. Various approaches can be used for the distributor to communicate with the game server and effect activation of the game card including loading of the game wallet. As can be appreciated, the particular card needs to be identified and this information provided to the game server by the authorized distributor. This could include scanning of a bar code or URI in combination with scanning of the card number or merely contacting of the game server and providing the card number to the game server. Many different activation arrangements can be used or combinations thereof.

The game server can include in memory the particular game associated with a particular game card and dollar value to be loaded in the game wallet. Therefore, this system functions effectively with respect to game cards or game carriers that require activation by a distributor much in the way that store gift cards are currently activated by distributors. The cards continue to have the machine readable code that must be properly revealed and then used by the user to access the game server. Such access to the game server is the same as earlier described given the wallet associated with the URI has been activated.

This system is also useful in redeeming funds that may be stored in the cash wallet associated with the particular URI. For example a player may have certain winnings and chosen to cash out. In this case the user could attend at an authorized distributor and provide to that distributor the game card with its unique URI. The distributor can then scan that URI, access the game server in a manner to automatically verify the identity of the distributor thereby simplifying redemption. In other embodiments the authorized distributor can provide information to confirm to the game server that proper access is being provided. As each game card is associated with the unique URI and this URI associates the particular game and wallet, access by the distributor can include the disclosure of funds that are available for redemption. The authorized distributor can then determine what funds can be redeemed and cash out the particular user. The game server and authorized distributor will include details of these transactions and effectively settle their account from time to time.

In a different embodiment of the invention the game server and a particular game card have been adapted to allow redemption of any cash value in the wallet associated with a particular URI of a game card by using a bank machine or banking facility. Basically the insertion of the game card in an ATM terminal or providing the game card to the bank personnel allows them to determine the funds that are available for redemption. This arrangement requires that the game card be recognized by the particular banking facility and properly authorized. Again there is full tracking of this information and the appropriate settlement of accounts between the game provider and the banking facility.

One of the advantages of the present system is the system allows a user to quickly access a game provided on a game server. When a user first purchases the game card they can use their computing device to scan the QuiQode™ 126, optionally provide any confirming information and initiate game play. There is no requirement for the user to establish an account with his own personal information and effectively fund his account. If the smart device is used to return to the particular URI, this URI can be saved on the device and thus the scanning step is not required. Shortcuts can also be stored on the device. The game server in association with the URI stores details of the particular device or provides the device with information to simplify the confirmation step. This arrangement assumes that if the same smart device contacts the game server using the game card information then this is a proper authorized access and game play is initiated.

If the user uses the same smart device to return to the game server, information has been stored in the smart device that allows the game server to automatically recognize the originating device and the user is able to initiate game play without any further confirmation or login step.

In some embodiments the user may wish to access the game server by using a different device. In this case the user could forward the URI to the different device to simplify access of that particular game server and game and wallet of the user. If a new device is used to access the game server a confirmation step may be required where the user is prompted to enter a further code such as the security code. Once so recognized or confirmed, information can be stored with that further device such that it is used to return to the game server at a later point in time using that particular URI game play can be directly accessed without going through the further security confirmation.

The unique URI's can be quite long and non sequential rendering them difficult to access without prior knowledge. Such URI's can provide their own level of security and be used with other security measures.

As can be appreciated from the above, this game system allows the user to access his particular game wallet and game using several different devices and in the case of a return to the game server using a known device, the game server recognizes the user and provides a one touch or a one click access of the particular game and game wallet.

With the above arrangement the game server tracks account type information with respect to a particular game and the game wallet thereof. The game server does not track the identity of the user and has not been provided with any credit card or other financial information of the particular user. The user merely purchases a game card from a distributor using any conventional payment method and the card is then authorized for game play with a predetermined value.

In the preferred embodiment if the wallet goes to a zero balance game play is stopped and the particular game card is terminated. In this embodiment the game card is disposable and if the user wishes to continue his game experience he would purchase a new game card. It may be possible to link his earlier game play or history by providing his former URI.

This approach of a disposable game card is preferred relative to a user merely returning to a distributor to provide additional funding that could be associated with his former wallet and game information. There may be certain applications, for example game history information that a user wishes to keep or game history information associated with particular games where it is desirable to keep this information. In this case the ability to return to a distributor or to top up the wallet in a different manner can be provided or other modifications to provide this functionality. Therefore, although the disposable aspect of the game card is considered to be advantageous, it need not be limited to this application alone.

One of the advantages of the present system is the ability to provide or authorize game cards without specialized dedicated components. The system is quite flexible with respect to allowing distributors to stock preloaded game cards or to allow these distributors to conveniently and quickly authorize game cards which have been purchased.

Regarding the actual play of the game and the wallet associated with a game card, it is preferable to track 3 separate amounts associated with the play of the game wherein:

Amount 1 is a total available play amount, Amount 2 is initial pre-loaded amount that may include an extra free monetary incentive bonus, Amount 3 is a Winnings amount. Upon purchasing the game and accessing the application for the first time, the amount that is shown in the application wallet is Amount 1, which corresponds to the initial pre-loaded Amount 2 (if any).

Once a wager amount for a game is selected and a bet for a game is placed, the wager amount is deducted from the Amount 2, which simultaneously is reflected in the Amount 1. Each following bet will result in a wager amount being deducted from the Amount 2 until the Amount 2 reaches 0. If any game play results in a win, the amount won is added to Amount 3, which simultaneously is reflected in Amount 1. Once Amount 2 reaches 0, every other following bet will result in a wager amount being deducted from Amount 3, which simultaneously is reflected in Amount 1. Once Amount 3 reaches 0, the gaming application is permanently exhausted. The amount that is available for cash-out is Amount 3 exclusively. If amount A has a remaining balance of Amount 2, the available for cash-out is calculated using the formula Amount 1−Amount 2=Amount 3.

For example the initial purchase amount (such as $100.00) is initially stored in the wallet. The individual distributor who sold the game is typically compensated by receiving a commission on the sale. The game server is compensated by charging for the games or effectively being compensated based on the wagered amounts. The redemption of the value of the card preferably does not include this purchase amount that in the preferred embodiment must be used to play the particular game or games. Any winnings associated with game play may be redeemable. Should a player wish to redeem a card that has only been partially used with respect to the initial purchase amount, for example he still has $25.00 of the $100.00 available for game play the redemption preferably will not return the $25.00.

It is preferable that the initial value associated with the wallet is not redeemable, but other arrangements are possible or variations of this system can be used. For example perhaps it is possible to redeem a portion of the initial purchase amount at a later point in time. For example it may be acceptable to redeem a portion of the purchase amount that is retained in the wallet if it is decreased by 50% or more. The main point is the game provider wants to be compensated with respect to the initial sale of the card and any distribution fee or other fee he has provided to the distributor.

The present system is particularly suited to the casual game player who does not wish to provide credit information to the game server and/or a player wanting quick access to game play. Such reservation with respect to providing personal and/or financial information of the user is avoided in the present game system and method. There can be many reasons why a user does not wish to be uniquely identified and the present invention overcomes these issues by providing an anonymous user with a unique URI and associated wallet that allows play of one or more games. The particular URI is disposable and if the wallet reaches a $0 amount the URI is preferably terminated.

There are certain circumstances when a user's personal identification, age and geo-location are required to satisfy regulatory requirements of specific jurisdictions to access a gaming application. The present system can obtain this information by downloading a dedicated scanning software application on the user's device.

The dedicated scanning software application has additional functionality that is preferably used to assure compliance with different regulatory requirement before connection to a game server. In this way the user's device is used to confirm compliance or initially confirm compliance.

Installing the dedicated scanning software application requires the user to complete a onetime registration process where personal information provided by the user is permanently associated with the installed dedicated scanning software application and stored with the game server. A username and/or a password may be set-up at the time of registration to allow future access and the use of the dedicated software to access a game.

The dedicated scanning software installed on the user's computing device, such as a smartphone, leverages the computing device's native web camera functionality to scan a machine readable code such as QR code displayed on a game card.

Scanning of the QR code links the device to a wagering game application that is then loaded on the device. A game URI is saved to the dedicated scanning application and the user's information.

Upon subsequent scanning of the QR code, the game server recognizes the dedicated scanning application being used to access the URI and recognizes the user's personal information including user's age, associated with the dedicated application and if satisfied, will permit the gaming application access and game play.

A second layer of age verification is also possible and may be conducted offline by the game card selling vendor in a manner similar to the age verification related to purchases of age restricted consumer products such as tobacco, alcohol, and lotteries.

A dedicated scanning application installed on a user's computing device such as smartphone may further leverage the device's native GPS functionality to identify user's geo-location.

A URI or other human readable or machine readable code, such as PIN or a serial number, placed on a tangible carrier is advantageously used to access a wagering application for game play. The URI or other code can be associated with a prepaid instrument used to fund a user's gaming account that may include a unique region or area identifier. With the URI also providing a location or region limitation for possible game play and the dedicated scanning application having the capability to receive separately determined location information, the dedicated scanning application can confirm compliance with the region specific limitations. Previously this type of compliance was carried out by the game server alone. With the present arrangement, the right to game play or game play access can be region or area specific and the logic for such an arrangement is shown in FIG. 7.

The geographic region or specific area can be defined by specific boundaries as part of the code or codes provided with the tangible carrier. The dedicated scanning application installed on user's computing device permanently stores these region and area qualifiers provided as part of the URI and the computing device. The user's computing device is able to recognize an identifier associated with the current location of the device to confirm that geo specific requirements are met.

In FIG. 7 the logic with respect to a dedicated scanning application having the capability of identifying a geographic limitation is shown. Basically the dedicated scanning application can be used in a conventional manner but it can also identify purchased games having a geographic limitation.

A user who has purchased a game would basically activate his device as indicated at 400 and start the dedicated scanning application as indicated at 402. The device then will scan the game card and acquire the game URI as indicated at step 404. After acquiring the game URI the dedicated scanning application can determine at step 406 whether the game includes a geographic location restriction. If the particular URI does include a geographic location restriction the software then determines whether the user's device at step 408 includes logic for determining the geographic location. If the determination of step 408 indicates that the device is not capable, then the dedicated software at step 410 requests the server for coordinates based on the IP address assigned by the internet local provider. If the device does include geographic location identification then at step 412 the application acquires the geographic coordinates from the device typically from a GPS function of the device. At step 414 the dedicated scanning application can determine whether or not the user can play the game given his current location either determined from step 410 or determined from step 412. If it is confirmed that the geographic location restriction has been met, the device can proceed and initiate the game at step 416. If it is determined that the geographic location restriction has not been met, step 418 indicates this result to the user and will not allow access to the game.

With the arrangement identified in FIG. 7, it can be appreciated that this dedicated scanning application not only provides a simple mechanism for obtaining the URI but it also provides additional capability for determining whether a geographic restriction is associated with the game, and furthermore whether the device due to its location meets such a geographic location restriction. This system is particularly advantageous in that the user's device, when loaded with the dedicated scanning application, determines whether the geographic restriction has been met. This would be in contrast to other systems that include a geographic restriction that is effectively determined by the game server. By providing this arrangement where the geographic restriction is determined by the user's device, the requirements of the game server are reduced. It can further be appreciated that in some applications it may be appropriate for the game server to further confirm the geographic location. Again, the load on the server is reduced as the end user's device has already determined many cases where the geographic location qualification has not been met. As can be appreciated there may be certain types of games where this double type confirmation of the geographic location is necessary. It is anticipated that for many game applications having a geographic restriction, that the end user device confirming qualification of the geographic restriction will be sufficient.

Upon deploying the dedicated scanning application, the user's location is identified and any assigned region/area identifier is recognized and compliance confirmation is required prior to game play.

Upon accessing the game URI, the dedicated scanning application recognizes the region identifier contained in the URI and verifies it against region/area identifier of user's current location. If region/area identifier of URI matches that of a user's current geo-location, the dedicated application allows access to the wagering game application for a game play.

The region identifier of the accessed URI is stored in the GPS enabled dedicated application for the duration of the game play and the user's geo-location is tracked by the GPS enabled dedicated application. If during game play the location of the user no longer satisfies the region identifier of the game play application, the dedicated application will terminate game play.

In other instances a region restricted gaming application may require a PIN input to allow users to access or fund a user's gaming account. In such cases, any such PIN provided for those purposes within any given region may also contain a region/area specific identifier.

With the present system and method the location identification function of the user's device is periodicly verified to maintain game compliance with the purchased game and/or to assure compliance with gaming provisions of a particular area or region. For the user this compliance confirmation occurs automatically by the application installed on the user's device incorporated with a game server.

Although various preferred embodiments of the present invention have been described herein in detail, it will be appreciated by those skilled in the art, that variations may be made thereto without departing from the appended claims.

The embodiments of the invention in which an exclusive property or privilege is claimed are defined as follows:

1. A method of authorizing game play associated with an online game server comprising the steps of
Purchasing a prepaid right to play one or more games available on a game server;
Receiving as part of said purchase a unique URI having associated therewith a wallet and access to one more game applications; and
Using said unique URI to access and play said one or more gaming applications with at least losses and winnings being tracked using said wallet.

2. A method as claimed in claim 1 wherein said step of purchasing the prepaid right includes purchasing a game card that includes thereon said unique URI.

3. A method as claimed in claim 1 wherein said step of purchasing the prepaid right includes purchasing a game card that includes thereon a machine readable code; said method further including using a device to scan the machine readable code and obtain said unique URI.

4. A method as claimed in claim 3 wherein said machine readable code on the game card is partially covered by a removable portion and said method includes removing said removable portion prior to scanning of said machine readable code.

5. A method as claimed in claim 3 wherein said step of purchasing said game card includes paying a monetary amount as indicated on the game card and providing in the wallet a game credit amount that allows play of said one or more games.

6. A method as claimed in claim 2 wherein purchasing of the game card with the prepaid right includes a purchase amount and a monetary bonus amount, and wherein said wallet is preloaded with both the purchase amount and the monetary bonus amount.

7. A method as claimed in claim 4 including using a smart phone having a QR scanning capability to obtain and use said unique URI.

8. A method as claimed in claim 5 including disabling access to play said one or more games when said game credit amount is zero.

9. A method as claimed in claim 6 wherein said game card includes a security code and said method includes responding to a prompt from said game server to correctly enter said security code prior to allowing game play.

10. A method as claimed in claim 8 including upon purchase of a game card, scanning said game card and notifying said game server of the activation of the game card and the game server activating the game card for use by the purchaser.

11. A method as claimed in claim 8 wherein each game card has been previously authorized for game play prior to purchase of the game card by a user.

12. A game card for accessing a game server, said game card including a tangible carrier with a machine readable code associated with a URI linked to a game and pre-loaded wallet on the game server specific to the game card.

13. A game card as claimed in claim 12 wherein said specific predefined URI is a unique pre-generated URI specific to the game card.

14. A game card as claimed in claim 12 wherein said URI is a common specific predefined URI and said game card includes a PIN required to access and play the game and associated preloaded wallet.

15. A game card as claimed in claim 13 including as part thereof a bank card with a magnetic stripe and having a size complying with CR80 standards; said bank card being specific to said unique pregenerated URI and allowing redemption of specific funds associated with said URI.

16. A game card as claimed in claim 14 wherein said tangible carrier includes an open-loop or semi-open loop bank card.

17. A game card as claimed in claim 14 wherein said tangible carrier includes a closed or semi-closed network card.

18. A game card as claimed in claim 12 including an Augmented Reality Image Target.

19. A game card as claimed in claim 13 wherein said game has a predetermined outcome specific to the game card and wherein said game card includes an Augmented Reality Image target providing an option for Augmented Reality game play revealing the predetermined outcome.

20. A game card as claimed in claim 13 wherein said tangible carrier includes a purchase amount on a face thereof and said preloaded wallet has a monetary value associated therewith that includes the purchase amount plus an incentive bonus for game play.

21. A game card as claimed in claim 13 wherein said game card includes a predetermined outcome and wherein said unique URI is additionally a unique Augmented Reality Marker usable to reveal the predetermined outcome through game play.

22. A game card as claimed in claim 12 wherein said wallet tracks
a) a total amount available for play;
b) an initial preloaded amount including a monetary incentive bonus; and
c) a winnings amount.

23. A game card as claimed in claim 22 wherein only the winning amount is available as a cashable amount.

24. A game card as claimed in claim 12 including a region specific area defined as part of said URL and game play is limited to said region specific area.

25. A game card as claimed in claim 12 wherein the game stored or the game server is limited to a region specific area requiring confirmation compliance prior to game play.

26. A game card as claimed in claim 13 wherein said PIN includes a region specific area requirement for game play.

27. A game card as claimed in claim 24 in combination with a user's computing device having a native GPS function that provides geographic location information of the computing device and wherein said computing device includes a dedicated scanning application, and wherein said dedicated scanning application, when used to scan a URI of a game, determines the region specific area and verifies that the geographic location of the user's computing device complies with the region specific area prior to initiation of game play.

28. A game card in combination as claimed in claim 27 wherein said dedicated scanning application uses the native GPS function to periodically determine the location of the user's computing device during game play and terminates game play if the determined location of the user's computing device no longer complies with the region specific area

29. A game card in combination as claimed in claim 27 wherein said specific pregenerated URI includes as part thereof the region specific requirement.

30. A game card in combination as claimed in claim 27 wherein said game card includes in combination with the URI a PIN for accessing game play and wherein said PIN includes as part thereof the region specific requirement to initiate and/or continue game.

31. A game card in combination as claimed in claim 30 wherein the user's computing device is a smart phone, a tablet or other smart device.
